(19) United States
(12) Patent Application Publication
(10) Pub. No.: US 2006/0099501 A1
(43) Pub. Date: May 11, 2006

(54) Secondary battery

(76) Inventors: Ka Youn Kim, Youngin-si (KR); Eui Sun Hong, Youngin-si (KR); Kyoung Woo Kim, Youngin-si (KR); Byung Jo Jung, Youngin-si (KR); Young Hwa Kwon, Youngin-si (KR); Jin Uk Lee, Youngin-si (KR); Hoon Yim, Youngin-si (KR); Kum Ok Kim, Youngin-si (KR)

Correspondence Address: CHRISTIE, PARKER & HALE, LLP, PO BOX 7068, PASADENA, CA, 91109-7068, US

(21) Appl. No.: 11/261,392

(22) Filed: Oct. 27, 2005

(30) Foreign Application Priority Data
Oct. 28, 2004 (KR) 10-2004-0086905
Oct. 28, 2004 (KR) 10-2004-0086895

(51) Int. Cl. H01M 2/08; H01M 2/04

(52) U.S. Cl. 429/174; 429/175

(57) ABSTRACT

A secondary battery having an electrode assembly with improved battery capacity. The secondary battery has an electrode assembly including two electrodes and a separator, a case made from an insulative material and having an opening at an upper portion thereof for receiving the electrode assembly therein, and a cap assembly including a cap plate made from an insulative material for sealing the opening to prevent the electrode assembly from being separated from the case.

### CROSS-REFERENCE TO RELATED APPLICATION

This application claims priority to and the benefit of Korean Patent Application Nos. 10-2004-0086905 and 10-2004-0086895, filed Oct. 28, 2004, the disclosures of which are hereby incorporated herein by reference in their entirety.

### BACKGROUND OF THE INVENTION

1. Field of the Invention

The present invention relates to a secondary battery, and more particularly to a secondary battery having an improved electric capacity per unit volume.

2. Description of the Prior Art

Recently, studies and research have been actively carried out in relation to secondary batteries due to the characteristics of the secondary batteries. Secondary batteries are rechargeable and may be fabricated in compact sizes with high capacity. Among secondary batteries, Ni-MH secondary batteries, Li secondary batteries and Li-ion secondary batteries have been extensively used.

In order to fabricate such a secondary battery, an electrode assembly including electrodes (a positive electrode and a negative electrode) and a separator is accommodated in a can made from aluminum or an aluminum alloy, and a cap assembly is assembled with the can. The can is sealed after an electrolyte has been injected into the can. The can may be made from, for example, iron or aluminum. If the can is made from aluminum or an aluminum alloy, the total weight of the secondary battery may be reduced and erosion of the secondary battery may be prevented even if the secondary battery has been used for a long period of time under high voltage conditions.

A sealed unit cell is combined with battery accessories and safety devices, such as a positive temperature coefficient (PTC) device, a thermal fuse and a protective circuit module (PCM). The sealed unit cell may be accommodated in a separate hard pack or may undergo a molding process using hot melt resin to form an exterior of the secondary battery.

FIG. 1 is an exploded perspective view of a conventional secondary battery and FIG. 2 is a front sectional view illustrating an upper portion of the conventional secondary battery.

Referring to FIGS. 1 and 2, the conventional secondary battery includes a square type can 11 having a substantially hexahedral shape, an electrode assembly 12 accommodated in the can 11, and a cap assembly coupled to an opened upper end of the can 11 in order to seal the opened upper end of the can 11.

The electrode assembly 12 may be formed by sequentially stacking or winding a first electrode 13, a separator 14, and a second electrode 15, which are in the form of thin films or thin plates.

When the first electrode 13 is a positive electrode, a positive electrode tab 16 is electrically connected to a predetermined area of a positive electrode collector of the positive electrode 13 which is absent a positive electrode active material layer. In addition, a negative electrode tab 17 is electrically connected to a predetermined area of a negative electrode collector of the negative electrode 15, which is absent a negative electrode active material layer.

The positive electrode 13, the negative electrode 15 and the positive and negative electrode tabs 16, 17 may have mutually different polarities. In addition, insulation tape 18 may be attached to boundary areas between the positive and negative electrode tabs 16, 17 and the positive and negative electrodes 13, 15 in order to prevent a short circuit from being generated by the boundary areas.

The separator 14 may have a width larger than the positive and negative electrodes 13 and 15 to prevent a short circuit between the electrodes.

The can 11 is made from aluminum or an aluminum alloy and has a substantially hexahedral shape. The electrode assembly 12 is accommodated in the can 11 through the opened upper end of the can 11. That is, the can 11 is a container for receiving the electrode assembly 12 and an electrolyte therein. In addition, the can 11 may act as a terminal.

The cap assembly includes a conductive cap plate 110, which is a flat plate having a size and a shape corresponding to the opened upper end of the can 11. The conductive cap plate 110 has a centrally located perforation hole 111 through which an electrode terminal is extendable. A gasket 120 is installed between the electrode terminal 130 extending through the center of the conductive cap plate 110 in order to electrically insulate the electrode terminal 130 from the conductive cap plate 110.

An insulation plate 140 is installed below the conductive cap plate 110 and a terminal plate 150 is positioned below the insulation plate 140. A lower surface of the electrode terminal 130 is electrically connected to the terminal plate 150.

The positive electrode tab 16 protruding from the positive electrode 13 is welded to a lower surface of the conductive cap plate 110 and the negative electrode tab 17 protruding from the negative electrode 15 is welded to a lower end of the electrode terminal 130 and may be folded several times.

In addition, an insulation case 190 is installed on an upper surface of the electrode assembly 12 in order to electrically insulate the electrode assembly 12 from the cap assembly while covering the upper end of the electrode assembly 12. The insulation case 190 may be made from high polymer resin such as polypropylene, having an insulative property. The insulation case 190 has a centrally located center portion thereof with a lead hole 191 through which the negative electrode tab 17 extends. In addition, the insulation case 190 may be formed at one side thereof with a perforation hole 192.

An electrolyte injection hole 112 is formed at one side of the conductive cap plate 110. In addition, a plug 160 is provided in order to seal the electrolyte injection hole 112 after the electrolyte has been injected through the conductive cap plate 110. The plug 160 may be fabricated by mechanically pressing a ball-shaped base metal, such as aluminum or an aluminum-containing metal after the ball-shaped base metal is placed on the electrolyte injection hole 112 of the conductive cap plate 110. The plug 160 is welded to a peripheral portion of the electrolyte injection hole 112 of the conductive cap plate 110 in order to seal the electrolyte injection hole 112. The cap assembly is coupled with the can 11 when a peripheral portion of the conductive cap plate 110 is welded to a sidewall of an opening of the can 11.

As secondary batteries are optimally lightweight and have a high capacity, it is desirable to develop secondary batteries having superior capacity per unit volume as compared to conventional secondary batteries. The conventional square type lithium ion secondary battery shown in FIGS. 1 and 2 has a relatively large volume to connect the tabs of the electrode assembly to the conductive cap plate.

Such a relatively large volume is unnecessary with respect to battery capacity although it is necessary for the safety and structural integrity of the secondary battery. Accordingly, there is a need for a secondary battery capable of using the relatively large volume of the secondary battery for improving battery capacity without compromising the safety of the battery.

### SUMMARY OF THE INVENTION

A secondary battery is provided which more effectively uses an internal space of a can to electrically connect a tab of an electrode assembly with a cap plate. The secondary battery provided may be easily fabricated with reduced manufacturing time. Additionally, the secondary battery provides a simple structure with a reduced number of components.

A secondary battery is provided including an electrode assembly including two electrodes and a separator; an insulative can or a metal can having an opening at an end thereof adapted to receive the electrode assembly therein; and an insulative cap plate for sealing the opening in order to prevent the electrode assembly from being separated from the insulative can.

According to an exemplary embodiment of the present invention, the insulative can and the insulative cap plate may be made from plastic, an engineering plastic or the like. Electrode tabs protrude from two electrodes of the electrode assembly and the insulative cap plate is formed with a hole having a predetermined size for allowing the electrode tab to protrude by passing through the hole. The insulative cap plate is formed with an electrolyte injection hole, which may be sealed by a plastic plug.

The secondary battery according to the present invention does not need an insulation case typically used for preventing a short circuit between electrode tabs of the electrode assembly and the can or between electrode tabs and the cap plate. Thus, the length of the electrode assembly may be increased and battery capacity may be improved.

In addition, according to the present invention it is not necessary to weld the electrode tab to the cap plate, thus reducing the time and cost for manufacturing the secondary battery.

Furthermore, according to exemplary embodiments of the present invention, the insulative can and the cap plate may be made from plastic materials and the structure of the cap assembly is simple, reducing not only the cost and time for manufacturing the secondary battery, but also the weight of the secondary battery.

### BRIEF DESCRIPTION OF THE DRAWINGS

FIG. 1 is an exploded perspective view of a conventional secondary battery.

FIG. 2 is a sectional view of a conventional secondary battery.

FIG. 3 is an exploded sectional view of a secondary battery according to one embodiment of the present invention.

FIG. 4 is a plan view illustrating a cap plate of a secondary battery according to one embodiment of the present invention.

FIG. 5 is an exploded sectional view illustrating the relationship between a protective circuit module and a secondary battery coupled with the protective circuit module according to one embodiment of the present invention.

FIG. 6 is a perspective view of a secondary battery according to one embodiment of the present invention.

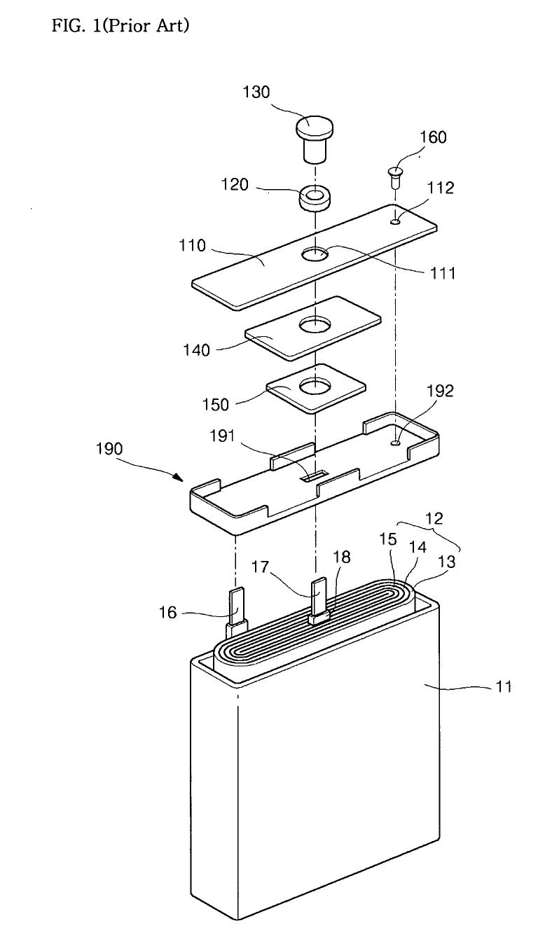

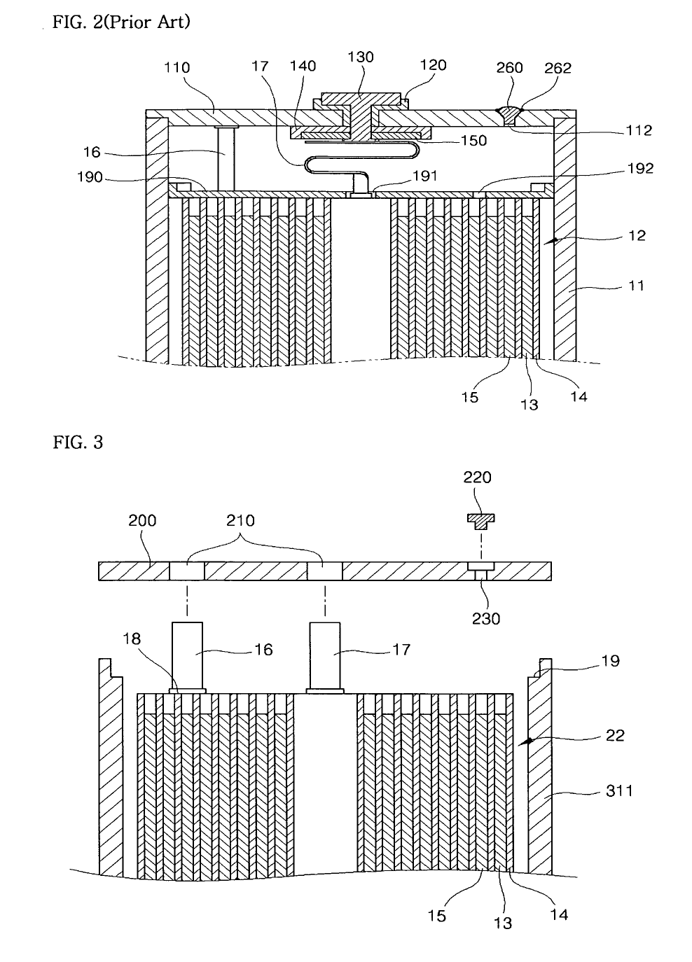

### DETAILED DESCRIPTION

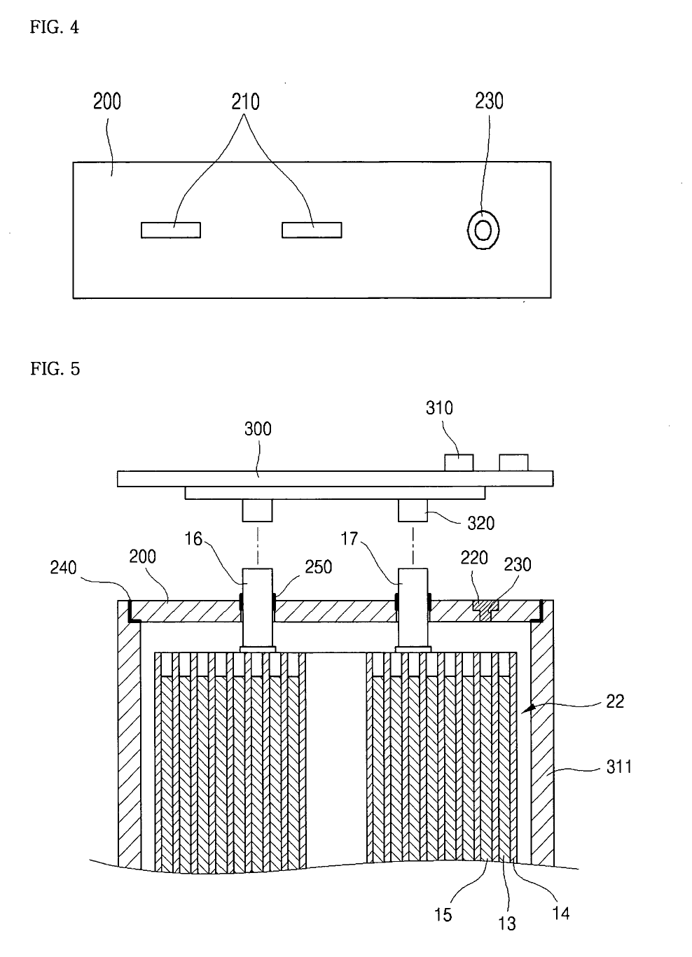

Referring to FIGS. 3 and 4, a square type lithium ion battery in the form of a bare cell includes a square type insulative can 11 having a substantially hexahedral shape, an electrode assembly 22 accommodated in the insulative can 11, and an insulative cap plate 200 coupled to an opened upper end of the insulative can 11 in order to seal the opened upper end of the insulative can 11.

The electrode assembly 22 may be formed by winding a stacked structure of a positive electrode 13, a separator 14, and a negative electrode 15, which may be in the form of thin films or thin plates. When winding the stacked structure, a separator may be provided at an outer portion of the negative electrode 15 to prevent a short circuit between the negative electrode 15 and the positive electrode 13.

The positive electrode 13 includes a positive electrode collector made from a thin metal plate having superior conductivity, such as an aluminum foil, and a positive electrode active material layer mainly including lithium-based oxide coated on both surfaces of the positive electrode collector. An electrode tab 16 (for example, a positive electrode tab) is electrically connected to a predetermined area of the positive electrode collector of the positive electrode 13, which is absent the positive electrode active material layer.

In addition, the negative electrode 15 includes a negative electrode collector made from a thin metal plate having superior conductivity, such as an aluminum foil, and a negative electrode active material layer mainly including carbon-based materials coated on both surfaces of the negative electrode collector. An electrode tab 17 (for example, a negative electrode tab) is electrically connected to a predetermined area of the negative electrode collector of the negative electrode 15 which is absent the negative electrode active material layer.

The positive electrode 13, the negative electrode 15 and the positive and negative electrode tabs 16, 17 may have mutually different polarities. In addition, insulation tape 18 may be attached to boundary areas between the positive and negative electrode tabs 16, 17 and the electrode assembly 22 to prevent a short circuit between the positive and negative electrode tabs 16, 17 and the positive and negative electrodes 13, 15.

The separator 14 may be made from polyethylene, polypropylene or copolymer of polyethylene and polypropylene. In one exemplary embodiment, the separator 14 has a width larger than the positive and negative electrodes 13, 15 to prevent a short circuit between the electrodes.

The insulative can 311 has a substantially hexahedral shape and is made from an insulative member, such as plastic, engineering plastic or the like. However, the present invention does not limit the materials for the insulative can 311. The electrode assembly 22 is accommodated in the insulative can 311 through the opened upper end of the insulative can 311. That is, the insulative can 311 is a container for receiving the electrode assembly 22 and an electrolyte therein. Since the insulative can 311 is made from an insulative material, the insulative can 311 cannot act as a terminal. In addition, according to an exemplary embodiment of the present invention, a stepped portion 19 is formed at an upper end of the insulative can 311 corresponding to the opened upper end of the insulative can 311. A cap plate 200 may be securely coupled with the stepped portion 19.

The cap plate 200 is a flat plate having a size and a shape corresponding to the opened upper end of the insulative can 311. The cap plate 200 is made from non-metallic materials, such as plastic, an engineering plastic or the like. However, the present invention does not limit the materials for the cap plate 200.

The cap plate 200 has at least one centrally located perforation hole 210 through which electrode tabs (for example, positive and negative tabs 16, 17) may extend. In addition, the cap plate 200 has an electrolyte injection hole 230 to allow electrolyte to be injected into the insulative can 311. After the cap plate 200 has been coupled with the stepped portion 19 formed at the upper end of the insulative can 311, the cap plate 200 may be securely fixed to the insulative can 311 by an adhesive or a thermal welding process.

Electrolyte may leak through gaps formed between the cap plate 200 and the tabs 16, 17 passing through the cap plate 200. To prevent the leakage of the electrolyte, the gaps may be sealed with a welding rod made from plastic having a superior bonding characteristic rather than tabs made from metal. In one exemplary embodiment, the gaps are sealed by filling the gaps with a filling agent or an adhesive which is used for bonding the cap plate to the opened upper end of the insulative can 311.

According to the present invention, it is not necessary to provide an insulation plate, a terminal plate, an electrode terminal or a gasket at a lower portion of the cap plate 200. In addition, the electrode tabs may linearly protrude from the electrode assembly 22 without being welded to an inner portion of the secondary battery or without being folded. Thus, it is possible to omit a polypropylene (PP) case or other insulative cases installed on the electrode assembly.

Therefore, according to the present invention, the length of the electrode assembly 22 may be increased due to the omitted unnecessary elements, thereby improving battery capacity. In addition, the secondary battery may be simple to assemble and may be fabricated at a low manufacturing cost. In addition, since the can and the cap plate are made from plastic instead of metal, the weight of the secondary battery may be reduced.

The electrolyte injection hole 230 is formed with a stepped portion such that the electrolyte injection hole 230 may be sealed with a plastic plug 220, instead of an aluminum ball which must be press-fitted into the electrolyte injection hole 230 and welded thereto. When the electrolyte injection hole 230 is sealed by means of the plastic plug 220, adhesive may be used for enhancing the sealing force. In addition, the plastic plug 220 may be screw-coupled into the electrolyte injection hole 230 by forming threads in the plastic plug 220 and in the electrolyte injection hole 230. It is also possible to use welding instead of adhesives to serve the plastic plug 220 to the electrolyte injection hole 230. Since the secondary battery has no insulative case, the electrolyte may be rapidly injected into the insulative can.

FIG. 5 is an exploded sectional view illustrating a protective circuit module connected to the secondary battery according to one embodiment of the present invention.

Referring to FIG. 5, the secondary battery may be fabricated in the same manner as the secondary battery described with respect to FIGS. 3 and 4, except that the cap plate 200 is coupled with the opened upper portion of the can 311 by means of an adhesive member 240 and gaps formed between electrode tabs 16, 17 and the holes of the cap plate 200 are sealed by means of an adhesive member 250.

The electrode tabs 16, 17 protruding through the holes of the cap plate 200 are welded to lead plates 320 of the protective circuit module 300. Reference numeral 310 represents an external input/output terminal.

The secondary battery in the form of a core cell, in which the bare cell is coupled with the protective circuit module, is installed in a mold. Hot melt resin may then be injected into the mold. Then, a curing process or a cooling process is carried out for a predetermined period of time so that the protective circuit module is tightly coupled with the bare cell absent a gap therebetween, thereby forming the exterior of the secondary battery as a hard pack.

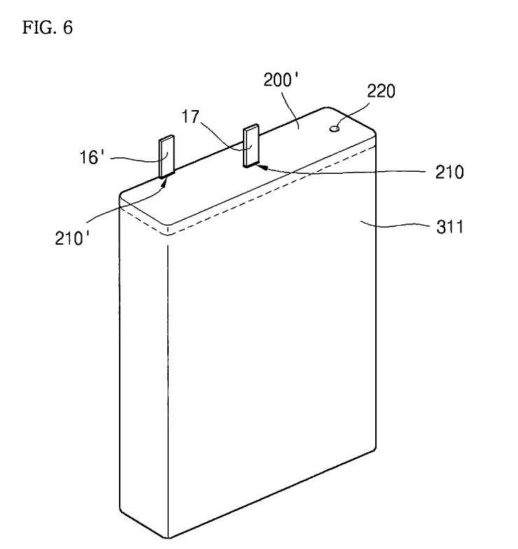

FIG. 6 is a perspective view of a secondary battery according to another exemplary embodiment of the present invention. Referring to FIG. 6, the secondary battery includes a can 311 as described above with respect to FIG. 5. The battery also includes a cap plate 200′ having a plastic plug 220 and a centrally located perforation hole 210 through which a negative electrode tab 17 protrudes. The cap plate 200′ further includes a second perforation hole 210′ located adjacent an exterior edge of the cap plate through which a positive electrode tab 16′ protrudes.

As mentioned above, the present invention may use an engineering plastic having superior weldability and workability with respect to the metal. Recently, engineering plastic having a weight lighter than aluminum and representing superior mechanical strength has been developed. In addition, the present invention may use an adhesive having superior chemical-resistant and heat-resistant characteristics such that the adhesive cannot be dissolved or decomposed by the electrolyte.

For instance, epoxy may be used as the adhesive applied between the insulative can and the cap plate. In this case, the curing time for epoxy may be shortened to improve process efficiency.

In addition, a recess may be provided at an outer peripheral portion of the cap plate such that a hole through which the electrode tab protrudes may be defined when the cap plate is coupled with the opened upper portion of the can.

As described above, the secondary battery according to the present invention may be absent an insulation case typically used for preventing a short circuit between the electrode tabs of the electrode assembly and the can or between the electrode tabs and the cap plate, so the length of the electrode assembly may be increased and battery capacity may be improved.

In addition, according to the present invention, it is not necessary to weld the electrode tab to the cap plate. Thus, the time and cost to manufacture the secondary battery may be reduced.

Furthermore, according to an exemplary embodiment of the present invention, the insulative can and the cap plate are made from plastic materials and the structure of the cap assembly is simplified so that not only are the time and cost to manufacture the secondary battery reduced, but also the weight of the secondary battery may be significantly reduced.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A secondary battery comprising:
an electrode assembly including two electrodes and a separator;
a case having an opening at an end thereof for receiving the electrode assembly therein; and
a cap assembly including a cap plate made from an insulative material, the cap assembly sealing the opening to prevent the electrode assembly from being separated from the case.

2. The secondary battery as claimed in claim 1, wherein the cap plate is made from plastic.

3. The secondary battery as claimed in claim 2, wherein the cap plate is made from an engineering plastic having a mechanical strength higher than the mechanical strength of aluminum.

4. The secondary battery as claimed in claim 1, wherein the cap plate is bonded to the case by an adhesive.

5. The secondary battery as claimed in claim 1, wherein the opening has a stepped portion at an end thereof to enlarge a contact area between the cap plate and the case.

6. The secondary battery as claimed in claim 1,
wherein electrode tabs protrude from the two electrodes of the electrode assembly, and
wherein the cap plate has a hole through which at least one of the electrode tabs protrudes.

7. The secondary battery as claimed in claim 6, wherein a gap formed between the hole and the electrode tab is sealed by a sealing member.

8. The secondary battery as claimed in claim 1,
wherein electrode tabs protrude from the two electrodes of the electrode assembly, and
wherein at least one of the electrode tabs extends out of the case while passing through a gap formed between the case and the cap plate.

9. The secondary battery as claimed in claim 8, wherein the cap plate has a recess at an outer peripheral portion thereof such that the recess defines a connection hole allowing communication between an outer portion of the secondary battery and an inner portion of the secondary battery when the cap plate is coupled with the case.

10. The secondary battery as claimed in claim 9,
wherein the connection hole, the recess and a gap formed between the case and the electrode tabs passing through the case are sealed by a sealing member.

11. The secondary battery as claimed in claim 6 or 10, wherein the sealing member comprises epoxy resin.

12. A secondary battery comprising:
an electrode assembly including two electrodes and a separator;
a case made from an insulative material and having an opening at an end thereof for receiving the electrode assembly therein; and
a cap assembly including a cap plate made from an insulative material for sealing the opening to prevent the electrode assembly from being separated from the case.

13. The secondary battery as claimed in claim 12, wherein the cap plate and the case are made from plastic.

14. The secondary battery as claimed in claim 13, wherein the plastic includes an engineering plastic having a mechanical strength higher than the mechanical strength of aluminum.

15. The secondary battery as claimed in claim 12, wherein the cap plate is bonded to the case by an adhesive.

16. The secondary battery as claimed in claim 12, wherein the cap plate is thermally bonded to the case.

17. The secondary battery as claimed in claim 12, wherein the opening has a stepped portion at an end portion thereof to enlarge a contact area between the cap plate and the case.

18. The secondary battery as claimed in claim 12,
wherein electrode tabs protrude from two electrodes of the electrode assembly, and
wherein the cap plate has a hole through which at least one of the electrode tabs extends.

19. The secondary battery as claimed in claim 18,
wherein a gap formed between the hole and the electrode tab is sealed by a sealing member.

20. The secondary battery as claimed in claim 12, wherein electrode tabs protrude from the two electrodes of the electrode assembly and at least one of the electrode tabs extends out of the case while passing through a gap formed between the case and the cap plate.

21. The secondary battery as claimed in claim 20, wherein the cap plate has a recess at an outer peripheral portion thereof such that the recess defines a connection hole allowing communication between an outer portion of the secondary battery and an inner portion of the secondary battery when the cap plate is coupled with the case.

22. The secondary battery as claimed in claim 21,
wherein the connection hole, the recess and a gap formed between the case and the electrode tab passing through the case are sealed by a sealing member.

23. The secondary battery as claimed in claim 19 or 22, wherein the sealing member comprises epoxy resin.

24. The secondary battery as claimed in claim 12, wherein the cap plate is made from a material substantially similar to a material used for the case.
